(19) United States
(12) Patent Application Publication
(10) Pub. No.: US 2019/0325548 A1
(43) Pub. Date: Oct. 24, 2019

(54) UNMANNED AERIAL VEHICLE PEOPLE DETECTION AND EVACUATION SYSTEMS

(71) Applicant: Carrier Corporation, Palm Beach Cardens, FL (US)

(72) Inventors: Chetanya Kumar, Hyderabad (IN); Guru Charan Kottur, Hyderabad (IN); Aditya Swami, Hyderabad (IN); Vinay Kumar Pancholi, Hyderabad (IN); Rohith Pasupuleti, Hyderabad (IN)

(21) Appl. No.: 16/044,761

(22) Filed: Jul. 25, 2018

(30) Foreign Application Priority Data
Apr. 18, 2018 (IN) 201811014785

(51) Int. Cl. G06Q 90/00; B64C 39/02; B66B 1/24; B66B 1/34; G06K 9/00

(52) U.S. Cl. CPC G06Q 90/205; B64C 39/024; B66B 1/2408; B64C 2201/141; G06K 9/00637; B64C 2201/12; B64C 2201/146; B66B 1/3461

(57) ABSTRACT

Unmanned aerial vehicle evacuation assistance systems and methods for a building are provided. The systems include an unmanned aerial vehicle having at least one sensor and an elevator system having an elevator controller and an elevator car. The unmanned aerial vehicle includes a processor, a memory, and a transceiver to communicate with the elevator controller, wherein the memory includes instructions for execution by the processor to communicate with the elevator system to dispatch the elevator car to a designated floor based on information obtained at the unmanned aerial vehicle by the at least one sensor.

### CROSS-REFERENCE TO RELATED APPLICATIONS

This application claims the benefit of Indian Application No. 201811014785, filed Apr. 18, 2018, which is incorporated herein by reference in its entirety.

### BACKGROUND

The subject matter disclosed herein generally relates to building systems and, more particularly, to unmanned aerial vehicle people detection and evacuation systems

Buildings having multiple stories are configured with elevator systems for transporting occupants between floors of the building. The elevator system includes an elevator shaft through which elevator cars may operate in a vertical motion to transport occupants between floors.

In the event of emergencies within buildings, typically occupants are directed to evacuate by foot (e.g., using stairs). However, during such events in high-rise buildings, such evacuation may not be efficient. Further, certain persons may have difficulty in evacuating using traditional means. Accordingly, improved mechanisms for efficiently evacuating a building are desirable.

### SUMMARY

According to some embodiments, unmanned aerial vehicle evacuation assistance systems of buildings are provided. The systems includes an unmanned aerial vehicle having at least one sensor and an elevator system having an elevator controller and an elevator car. The unmanned aerial vehicle includes a processor, a memory, and a transceiver to communicate with the elevator controller, wherein the memory includes instructions for execution by the processor to communicate with the elevator system to dispatch the elevator car to a designated floor based on information obtained at the unmanned aerial vehicle by the at least one sensor.

In addition to one or more of the features described above, or as an alternative, further embodiments of the systems may include that the at least one sensor includes at least one of a thermal radiation detector, an infrared radiation detector, a radio radiation detector, an audio detector, and a visible radiation detector.

In addition to one or more of the features described above, or as an alternative, further embodiments of the systems may include a housing, wherein the unmanned aerial vehicle is stored within the housing when not in use.

In addition to one or more of the features described above, or as an alternative, further embodiments of the systems may include that the processor of the unmanned aerial vehicle processes data from the at least one sensor to determine the presence of occupants of the building and the unmanned aerial vehicle communicates with the elevator system to dispatch the elevator car to evacuate the detected occupants.

In addition to one or more of the features described above, or as an alternative, further embodiments of the systems may include that the unmanned aerial vehicle includes a projector, wherein the unmanned aerial vehicle projects one or more images from the projector to aid an occupant with evacuation from the building.

In addition to one or more of the features described above, or as an alternative, further embodiments of the systems may include that the unmanned aerial vehicle includes a speaker, wherein the unmanned aerial vehicle generates one or more audio notification from the speaker to aid an occupant with evacuation from the building.

In addition to one or more of the features described above, or as an alternative, further embodiments of the systems may include an emergency system including one or more detectors to detect an emergency within the building, wherein the unmanned aerial vehicle is deployed in response to an emergency detected by the emergency system.

In addition to one or more of the features described above, or as an alternative, further embodiments of the systems may include that the emergency system includes at least one of a manual activation alarm system and a smoke detector.

In addition to one or more of the features described above, or as an alternative, further embodiments of the systems may include that the memory of the unmanned aerial vehicle includes instructions for execution by the processor to transmit information to emergency personnel using the transceiver.

In addition to one or more of the features described above, or as an alternative, further embodiments of the systems may include that processor of the unmanned aerial vehicle includes instructions in the memory to process inputs received from an operator and control the operation of the unmanned aerial vehicle.

In addition to one or more of the features described above, or as an alternative, further embodiments of the systems may include that the unmanned aerial vehicle is programmed for autonomous operation.

According to some embodiments, methods for evacuating a building are provided. The methods include detecting an emergency within the building, deploying an unmanned aerial vehicle in response to the detected emergency, monitoring at least a part of the building with the unmanned aerial vehicle, and dispatching an elevator car in response to the monitoring by the unmanned aerial vehicle.

In addition to one or more of the features described above, or as an alternative, further embodiments of the methods may include that the monitoring by the unmanned aerial vehicle comprises at least one of making detections using thermal radiation, infrared radiation, radio radiation, audio, and visible radiation.

In addition to one or more of the features described above, or as an alternative, further embodiments of the methods may include projecting one or more images from a projector of the unmanned aerial vehicle.

In addition to one or more of the features described above, or as an alternative, further embodiments of the methods may include generating one or more audio notifications from a speaker of the unmanned aerial vehicle.

In addition to one or more of the features described above, or as an alternative, further embodiments of the methods may include transmitting information from the unmanned aerial vehicle to emergency personnel using a transceiver of the unmanned aerial vehicle.

In addition to one or more of the features described above, or as an alternative, further embodiments of the methods may include receiving, at the unmanned aerial vehicle, commands from an operator to control operation of the unmanned aerial vehicle.

In addition to one or more of the features described above, or as an alternative, further embodiments of the methods may include transmitting from the unmanned aerial vehicle an instruction to an elevator controller to dispatch the elevator car.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of a multi-story building having an air conditioning system and an elevator system;

FIG. 2 is a schematic illustration of an elevator system that may employ various embodiments of the present disclosure;

FIG. 3 is a schematic illustration of a building having an unmanned aerial vehicle evacuation assistance system in accordance with an embodiment of the present disclosure; and

FIG. 4 is flow process for operating a unmanned aerial vehicle evacuation assistance system in accordance with the present disclosure

### DETAILED DESCRIPTION

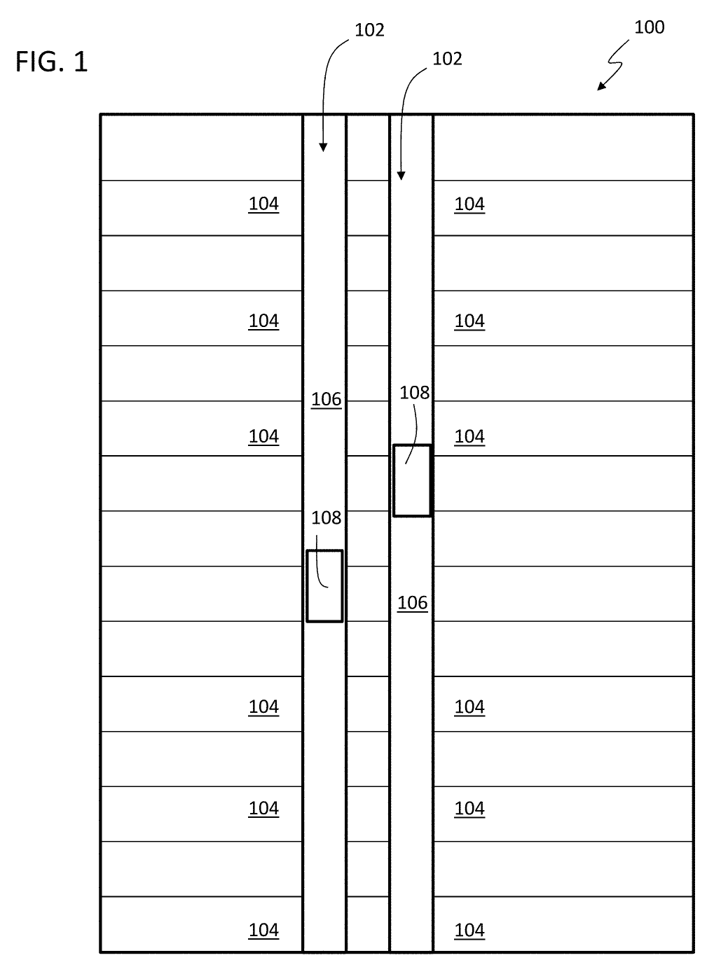

FIG. 1 is a configuration of a building 100 having an elevator system 102 arranged to convey passengers between a plurality of floors 104 of the building 100. As shown, the elevator system 102 includes two elevator shafts 106, wherein at least one elevator car 108 is arranged to travel within each of the elevator shafts 106. The floors 104 may be residential, commercial, or otherwise, wherein people can travel between the floors 104 by use of the elevator system 102, or by stairs, as will be appreciated by those of skill in the art.

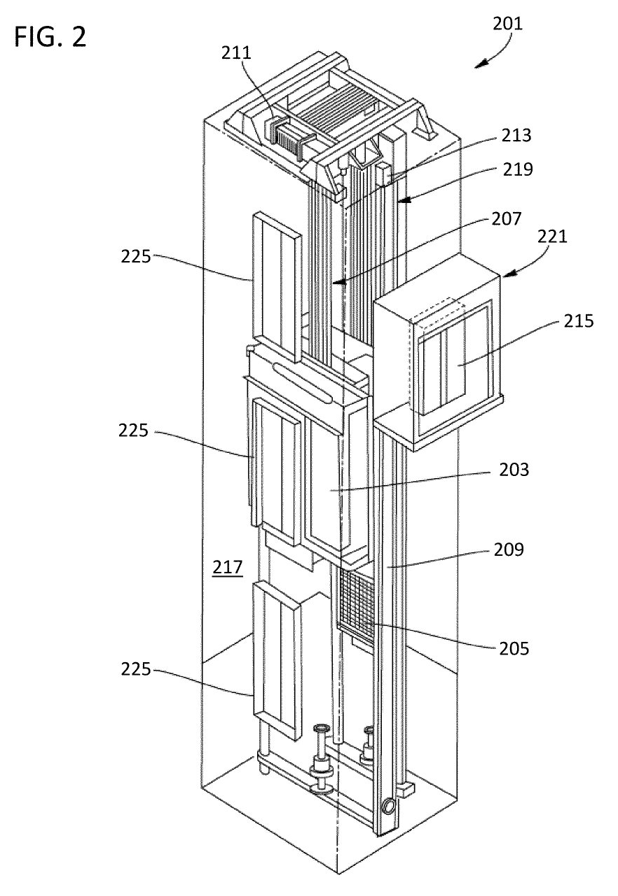

Turning to FIG. 2, a perspective view of an elevator system 201 including an elevator car 203, a counterweight 205, a roping 207, a guide rail 209, a machine 211, a position encoder 213, and an elevator controller 215. The elevator system 201 may be part of the elevator system 102 shown in FIG. 1, and may be arranged to provide service between one or more floors 104 of the building 100.

The elevator car 203 and counterweight 205 are connected to each other by the roping 207. The roping 207 may include or be configured as, for example, ropes, steel cables, and/or coated-steel belts. The counterweight 205 is configured to balance a load of the elevator car 203 and is configured to facilitate movement of the elevator car 203 concurrently and in an opposite direction with respect to the counterweight 205 within an elevator shaft 217 and along the guide rail 209.

The roping 207 engages the machine 211, which, in this illustrative embodiment, is part of an overhead structure of the elevator system 201, although other arrangements are possible without departing from the scope of the present disclosure. The machine 211 is configured to control movement between the elevator car 203 and the counterweight 205. The position encoder 213 may be mounted on an upper sheave of a speed-governor system 219 and may be configured to provide position signals related to a position of the elevator car 203 within the elevator shaft 217. In other embodiments, the position encoder 213 may be directly mounted to a moving component of the machine 211, or may be located in other positions and/or configurations as known in the art.

The elevator controller 215 is located, as shown in the illustrative arrangement, in a controller room 221 of the elevator shaft 217 and is configured to control the operation of the elevator system 201, and particularly the elevator car 203. In other embodiments the controller 215 can be located in other locations, including, but not limited to, fixed to a landing or landing door or located in a cabinet at a landing. The elevator controller 215 may provide drive signals to the machine 211 to control the acceleration, deceleration, leveling, stopping, etc. of the elevator car 203. The elevator controller 215 may also be configured to receive position signals from the position encoder 213. When moving up or down within the elevator shaft 217 along guide rail 209, the elevator car 203 may stop at one or more landings 225 as controlled by the elevator controller 215. Although shown in a controller room 221, those of skill in the art will appreciate that the elevator controller 215 can be located and/or configured in other locations or positions within the elevator system 201.

The machine 211 may include a motor or similar driving mechanism. In accordance with embodiments of the disclosure, the machine 211 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 2 is merely a non-limiting example presented for illustrative and explanatory purposes.

In case of emergencies in buildings, such as building 100, safe evacuation of occupants is a high priority and may be challenging due to building size and number of occupants (e.g., high number of floors can result in challenge for efficient and safe evacuation of occupants). Moreover, certain occupants may have disabilities or other conditions that may impair their ability to efficiently evacuate in the event of an emergency (e.g., blind, deaf, wheel-chair bound, etc.). Some such occupants may have a difficult experience with navigating and/or understanding instructions for evacuation (e.g., illustrative panels, lighted signs, general audio announcements, etc.). Moreover, in the event of fires and smoke, excessive smoke may prevent emergency personnel to accurately detect a number of occupants stuck located within a building, and the respective locations thereof. Furthermore, optimizing an evacuation route may be a challenge, because each emergency situation may be different and thus safe evacuation may depend on the given circumstances, including location(s) of emergency situation, number of occupants, state of occupants, location of occupants, etc.

Accordingly, embodiments provided herein are directed to unmanned aerial vehicle (“UAV”) people detection and evacuation systems that are integrated into a building. The unmanned aerial vehicles of the present disclosure are associated with one or more buildings and are configured to detect persons within a building during an emergency situation and to enable an efficient evacuation of such persons from the building. For purposes of clarity, an emergency situation may include the receipt of one or more indications of one or more hazardous conditions known to be likely to cause an emergency, for a period of time until an indication is received of the end of a hazardous condition, which may, for example, occur if an alarm is cancelled at a fire control panel or through other means.

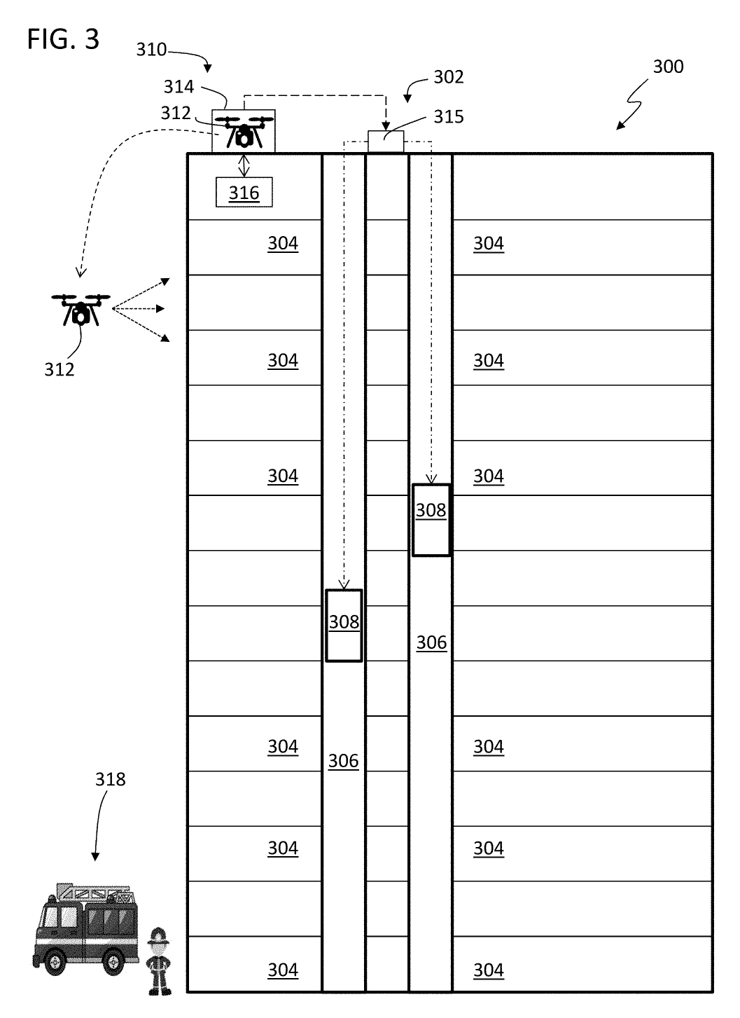

FIG. 3 is a configuration of a building 300 having an elevator system 302 arranged to convey passengers between a plurality of floors 304 of the building 300 and an integrated UAV evacuation assistance system 310. As shown, the elevator system 302 includes two elevator shafts 306, wherein at least one elevator car 308 is arranged to travel within each of the elevator shafts 306. The floors 304 may be residential, commercial, or otherwise, wherein people can travel between the floors 304 by use of the elevator system 302, or by stairs, as will be appreciated by those of skill in the art. The elevator system 302 may be similar to that shown and described with respect to FIG. 2. As shown, the elevator system 302 includes an elevator controller 315 that is operably connected to the elevator cars 308 and arranged to control operation and movement of the elevator cars 308 within the elevator shafts 306.

The UAV evacuation assistance system 310 includes an unmanned aerial vehicle (UAV) 312 that is housed within a housing 314. Although shown proximate to the roof of the building 300 in FIG. 3, UAV 312 may be housed within a housing located in the vicinity of the building 300, e.g., at ground level or on a neighboring building or structure. The UAV evacuation assistance system 310 is connected to an in communication with an emergency system 316 of the building 300. The emergency system 316 may be a hardwired or wirelessly communicatively connected system that includes detection and notification components such as smoke detectors, manual pull alarms, video systems, and/or other components/features which may detect and/or provide indications of hazardous conditions known to be likely to cause an emergency as will be appreciated by those of skill in the art. The emergency system 316 may include various additional communicatively connected components, e.g., user-interface and system interface components, such as control panels, displays, monitors, audio/visual components, connection to local emergency service (e.g., police, fire, rescue, etc.) which may record information and notify occupants and emergency services of information about indications of hazardous conditions, as will be appreciated by those of skill in the art.

In the event of receiving an indication of an emergency, the emergency system 316 will trigger or otherwise activate the UAV evacuation assistance system 310. Upon activation, the UAV 312 will leave the housing 314 and travel around and/or within the building 300 to aid in an evacuation of occupants within the building 300.

During an emergency situation, which may require evacuation of all occupants of the building 300 or a portion thereof, the UAV 312 is programmed or operated to travel around or within the building 300. For example, in one non-limiting embodiment, the UVA 312 will travel around the outside of the building 300 and capture a combination of various data, including, but not limited to: thermal radiation, infrared radiation, radio radiation, audio, visible radiation (i.e., optical/visual), etc. That is, the UAV 312 includes one or more sensors arranged to detect various characteristics of the building, including detection of people, smoke, fire, etc.

As noted, the UAV 312 may be programmed or controlled. That is, in some embodiments, the UAV 312 may be remotely operated by an operator to control movement and position thereof. Control of such UAV 312 is known and will be readily appreciated by those of skill in the art. Alternatively, the UAV 312 may be autonomous or substantially autonomous, with programming to control and dictate movement and position thereof. Such programming may include a blueprint, schematic, GPS coordinates, etc. of the building 300 (or associated coordinates thereof) such that the UAV 312 is programmed to maneuver relative to the layout and structure of the building 300. In the event of receiving an indication of an emergency, the UAV 312 may be programmed to travel to an appropriate position relative to the building 300. For example, if an emergency situation (e.g., fire) is indicated or reported on a given floor 304 of the building 300, e.g., indicated or reported by one or more detection and notification components placed at or in communication with the given floor 304, the UAV 312 may automatically travel to a position relative to the given floor 304 and make observations thereof. Further, depending on the building configuration, the UAV 312 may travel to an appropriate side of the building 300 to enable viewing of a region of the building 300 that includes the indicated emergency situation(s).

The programming and operation of the UAV 312 may be performed using a processor, integrated circuit, or other electronic control element as known in the art, which are located onboard the UAV 312. The processor may be operably connected to and/or in communication with electronic memory for storage, processing, and retrieval of instructions and/or processing collected data. The memory may be read-only and/or random-access, depending on the requirements of the UAV and the particular task performed thereby. Further, various communications components may be incorporated into the UAV 312, including, but not limited to Wi-Fi connectivity, near-field communication connectivity, Bluetooth connectivity, etc. Accordingly, the UAV 312 may include one or more transceivers for transmitting and/or receiving data and/or instructions. Further, the UAV 312 can include various location components, such as GPS, Wi-Fi, proximity detectors, etc.

Using the sensors of the UAV 312, a determination regarding the status of occupants of the building 300 may be made. For example, the UAV 312 and/or the UAV evacuation assistance system 310 may determine a number of people stuck per floor and dynamically dispatch an elevator to the appropriate floor using designed algorithms. The UAV evacuation assistance system 310 may include a processor and supporting electronics, such as memory and communications components, to enable communication with the UAV 312. That is, the UAV evacuation assistance system 310 may be or may include various computer/computing components to enable execution of processes, data storage, and/or electronic communication. Data obtained at or by the UAV 312 may be transmitted to the UAV evacuation assistance system 310 and/or to the emergency system 316.

When the UAV evacuation assistance system 310 determines that one or more occupants may be located on or near a floor 304 having an emergency, the UAV evacuation assistance system 310 can trigger control of the elevator system 302 to provide for an efficient evacuation of the indicated floors 304. In such operation, a determination is made that one or more occupants require evacuation from a given floor 304. The UAV evacuation assistance system 310 then triggers the elevator controller 315 to direct an elevator car 308 to the indicated floor 304. As such, an efficient evacuation of the floor 304 may be achieved.

Further, the UAV 312 can be configured to provide instructions to persons or occupants of the building 300. In such embodiments, the UAV 312 includes a speaker or other audio generation element that can provide audio (e.g., voice) commands and information to occupants. For example, the UAV 312 can provide auditory instructions to a blind person by voice commands to instruct such person to the closest exit for elevator. Additionally, or alternatively, the UAV 312 can include lighting and/or projection means to project images onto surfaces. For example, in such arrangements the UAV 312 can project sign language or other visual communications for deaf persons using Holographic images (e.g., using a basic projection technique). It should be evident that certain visual indications may also be of assistance to any sighted person that may view the projected images. Further, in some embodiments, the projection may be a floor map or other directional or spatial indicator to provide visual imagery and context to persons within a building. For example, in some embodiments, projected directional arrows and/or a floor map with instructions highlighted in different colors may be projected from the UAV 312, e.g., instructions about evacuation procedures or other actions such as sheltering in place. The floor map or other data associated with the images and projection may be stored on memory of the UAV 312.

As noted, the UAV 312 may be operated or programmed to travel about an exterior of the building 300. However, in some embodiments, the UAV 312 may be operated or programmed to travel within the building 300. When inside the building 300, the UAV 312 can travel to designated floors associated with an emergency situation (e.g., the floor having an emergency and/or floors adjacent there to, i.e., above/below). The UAV 312 may then travel to locations where occupants are detected and thus provide assistance to such persons to efficiently evacuate.

In some embodiments, the UAV 312, the UAV evacuation assistance system 310, and/or the emergency system 316 of the building 300 may be in communication with emergency personnel 318. Emergency personnel 318 can include fire, rescue, or other emergency personnel that may respond to an emergency within the building 300. In some embodiments of emergency system 316, communication with emergency personnel may be coordinated by or transmitted through the user-interface and/or system interface components of the emergency system 316. The information sent to the emergency personnel 318 can include visual data to provide information to the emergency personnel 318. As such, the emergency personnel may accurately and efficiently locate occupants of the building 300. For example, various sensors on the UAV 312 can enable visual imaging through smoke and provide insight to the emergency personnel using algorithms of the present disclosure. Moreover, such visual information can be provided to the emergency personnel 318 to enable foreknowledge of hazards to the emergency personnel 318 as they enter the building 300 (e.g., gas leaks, fallen debris, damage to the building, etc.).

Further, in some embodiments, the UAV evacuation assistance system 310 can provide optimum entry pathways inside the building to the emergency personnel 318 to avoid or minimize delay in emergency response while eliminating or minimizing interference with evacuation of occupants of the building 300.

In embodiments where the UAV 312 is controlled by a user, various control mechanisms may be used without departing from the scope of the present disclosure. For example, in some embodiments, a mobile device application can be used to interface with the UAV evacuation assistance system 310 and/or the UAV 312 to enable control thereof. Alternatively, control may be restricted to the specific emergency system 316 of the building 300 (e.g., in a security office, etc.). The control can be provided for complete manual control (e.g., controlling location, facing direction, etc.) or for inputs for desired destinations, with the travel of the UAV 312 performed autonomously based on programming, as will be appreciated by those of skill in the art. That is, the UAV 312 may be programmed for autonomous operation, with programming instructions stored on memory of the UAV 312 and executed by a processor thereof. Manual control can be provided from a remote user or operator that transmits instructions or control commands to the UAV 312 over a wireless communication connection between the operator (or computing system of the operator) and the UAV 312.

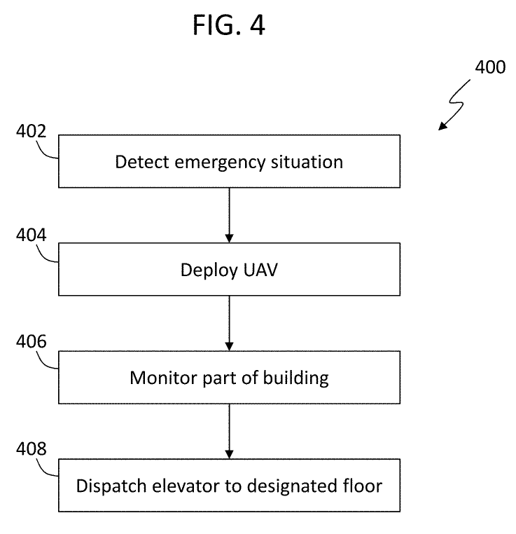

Turning now to FIG. 4, a flow process 400 for operating a UAV evacuation assistance system in accordance with the present disclosure is shown. The flow process 400 may be implemented by a UAV evacuation assistance system and/or emergency system of a building (e.g., UAV evacuation assistance system 310 and/or UAV 312 shown and described with respect to FIG. 3).

At block 402, an emergency is detected within a building. The detection may be based on one or more indications provided by one or more communicatively connected detection and notification components, such as a manual activation alarm system activated by an occupant of the building, a detector that detects a hazardous condition (e.g., a smoke detector or a toxic gas detector), or other alarm or monitoring system of the building. The manual activation alarm system may include manual pull levers, push buttons, or other types of physical (e.g., electronic or mechanical) manual actuation elements to enable an occupant to manual indicate the occurrence of an emergency.

At block 404, a UAV is deployed. The deployment may be from a housing located at, on, or near the building (e.g., building 300 shown and described with respect to FIG. 3).

At block 406, the UAV monitors a portion of the building. For example, the UAV may fly outside of the building in an area near where an indication was originated that the emergency is ongoing (e.g., side of building, specific floor(s), etc.). The UAV may monitor for occupants within the building and determine if an evacuation is necessary of such occupants.

If it is determined, at block 406, that the occupants should be evacuated, the UAV evacuation assistance system will signal to an elevator controller that an elevator is required at a designated location. That is, the UAV evacuation assistance system can enable the dispatch of an elevator car to a specific location within the building to enable an efficient evacuation of the building.

Accordingly, at block 408, an elevator car is dispatched to the indicated floor.

As noted above, the UAV may be configured to travel within the building, in addition to or alternative to the exterior. The UAV may provide the same functionality of dispatching elevator cars to specific floors, but may provide additional functionality. For example, the UAV may provide visual and auditory information to occupants of the building, such as indicating an evacuation route.

Advantageously, embodiments described herein provide UAV evacuation assistance systems for buildings. Advantageously, such systems may be integrated or in communication with elevator systems of the building such that efficient dispatch of elevator cars to necessary floors of a building may be achieved.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. An unmanned aerial vehicle evacuation assistance system of a building, the system comprising:
an unmanned aerial vehicle having at least one sensor; and
an elevator system having an elevator controller and an elevator car;
wherein the unmanned aerial vehicle includes a processor, a memory, and a transceiver to communicate with the elevator controller, wherein the memory includes instructions for execution by the processor to communicate with the elevator system to dispatch the elevator car to a designated floor based on information obtained at the unmanned aerial vehicle by the at least one sensor.

2. The system of claim 1, wherein the at least one sensor includes at least one of a thermal radiation detector, an infrared radiation detector, a radio radiation detector, an audio detector, and a visible radiation detector.

3. The system of claim 1, further comprising a housing, wherein the unmanned aerial vehicle is stored within the housing when not in use.

4. The system of claim 1, wherein the processor of the unmanned aerial vehicle processes data from the at least one sensor to determine the presence of occupants of the building and the unmanned aerial vehicle communicates with the elevator system to dispatch the elevator car to evacuate the detected occupants.

5. The system of claim 1, wherein the unmanned aerial vehicle includes a projector, wherein the unmanned aerial vehicle projects one or more images from the projector to aid an occupant with evacuation from the building.

6. The system of claim 1, wherein the unmanned aerial vehicle includes a speaker, wherein the unmanned aerial vehicle generates one or more audio notification from the speaker to aid an occupant with evacuation from the building.

7. The system of claim 1, further comprising an emergency system including one or more detectors to detect an emergency within the building, wherein the unmanned aerial vehicle is deployed in response to an emergency detected by the emergency system.

8. The system of claim 7, wherein the emergency system includes at least one of a manual activation alarm system and a smoke detector.

9. The system of claim 1, wherein the memory of the unmanned aerial vehicle includes instructions for execution by the processor to transmit information to emergency personnel using the transceiver.

10. The system of claim 1, wherein processor of the unmanned aerial vehicle includes instructions in the memory to process inputs received from an operator and control the operation of the unmanned aerial vehicle.

11. The system of claim 1, wherein the unmanned aerial vehicle is programmed for autonomous operation.

12. A method for evacuating a building, the method comprising:
detecting an emergency within the building;
deploying an unmanned aerial vehicle in response to the detected emergency;
monitoring at least a part of the building with the unmanned aerial vehicle; and
dispatching an elevator car in response to the monitoring by the unmanned aerial vehicle.

13. The method of claim 12, wherein the monitoring by the unmanned aerial vehicle comprises at least one of making detections using thermal radiation, infrared radiation, radio radiation, audio, and visible radiation.

14. The method of claim 12, further comprising projecting one or more images from a projector of the unmanned aerial vehicle.

15. The method of claim 12, further comprising generating one or more audio notifications from a speaker of the unmanned aerial vehicle.

16. The method of claim 12, further comprising transmitting information from the unmanned aerial vehicle to emergency personnel using a transceiver of the unmanned aerial vehicle.

17. The method of claim 12, further comprising receiving, at the unmanned aerial vehicle, commands from an operator to control operation of the unmanned aerial vehicle.

18. The method of claim 12, further comprising transmitting from the unmanned aerial vehicle an instruction to an elevator controller to dispatch the elevator car.
